(19) United States
(12) Patent Application Publication
(10) Pub. No.: US 2020/0265323 A1
(43) Pub. Date: Aug. 20, 2020

(54) System and Process of Prediction Through The Use of Latent Semantic Indexing

(71) Applicants: Kevin Erich Heinrich, Collierville, TN (US); Ramin Homayouni, Memphis, TN (US); Bradford Ryan Silver, Memphis, TN (US)

(72) Inventors: Kevin Erich Heinrich, Collierville, TN (US); Ramin Homayouni, Memphis, TN (US); Bradford Ryan Silver, Memphis, TN (US)

(21) Appl. No.: 16/280,099

(22) Filed: Feb. 20, 2019

(51) Int. Cl. G06N 5/02; G06F 16/35; G06F 17/27

(52) U.S. Cl. CPC G06N 5/02; G06F 17/2785; G06F 16/35

(57) ABSTRACT

The present invention is a modeling system and process for predicting individual outcomes and conditions from written database records of a population of individuals, using iterative variation of parameters. Individual subject documents are created by concatenation of unstructured text fields from the written database records of individuals, and these are processed using Natural Language Processing. An individual subject document corpus is built, and terms in the corpus are weighted and mapped to standard vocabularies. A term-by-document matrix is built and its dimensionality is reduced by Latent Semantic Indexing. Individual and term queries are combined and scored, producing a ranked list. The parameters of the model are iteratively optimized for an input list of individuals with corresponding condition, action, or outcome score values.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### CLAIM TO PRIORITY

This application claims under 35 U.S.C. § 120, the benefit of the application Ser. No. 14/494,582, filed Sep. 23, 2014, titled “System and Method of Prediction though the Use of Latent Semantic Indexing” which is hereby incorporated by reference in its entirety.

### BACKGROUND

Statistical and Machine Learning (ML) algorithms have been implemented in many domains and disciplines (consumer marketing, social networks, healthcare, national defense, law enforcement, etc.) to predict individuals within a defined population who have specific behaviors or characteristics.

For example, in healthcare, predictive modeling has been utilized for several decades. Statistical approaches such as linear regression, mixed-effects, and Bayesian models can be trained on a set of individuals with a given outcome using discrete data from their written records (such as lab values, vital signs, ICD10 and CPT codes, etc.) and then applied to a new set of individuals to predict specific outcomes. A large variety of statistical models have been reported that predict adverse events, infections, hospital admissions, cost, or risk of chronic diseases and complications. For healthcare and other domains and disciplines, current modeling approaches use structured fields in records that are highly specific to a given condition and are not generalizable to other conditions.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a flowchart representing the process of building a corpus, calculating term weights, summarizing individuals and performing matrix factorization consistent with certain embodiments of the present invention.

FIG. 2 is a flowchart representing the process of querying the concept matrix, combining and scoring multiple queries, and producing a ranked (prioritized) list of individuals consistent with certain embodiments of the present invention.

FIG. 3 is an embodiment of the system and process user interface showing a ranking of individuals based on conceptual similarity to a single query or plurality of queries, where a query can be any term, combination of terms, entire individual record, or combination of individual records, consistent with certain embodiments of the present invention.

FIG. 4 is an embodiment of the system and process user interface showing a ranked list of individuals in a given population according to semantic similarities to multiple queries consistent with certain embodiments of the present invention.

FIG. 5 is a flowchart representing the process of predictive modeling, where the model is trained based on a set of individuals from the population corpus with the desired characteristics or outcomes, is optimized and is applied to a new population of individuals to produce a ranked list of individuals with high likelihood of having the desired condition, action, or outcome consistent with certain embodiments of the present invention.

FIG. 6 is an embodiment of the system and process user interface which allows users to select a training population, specify model parameters, and execute the predictive model on a new target population consistent with certain embodiments of the present invention.

FIG. 7 is an embodiment of the system and process user interface which displays the output of an optimized model on a selected population consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an exemplary embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference herein to “corpus” refers to a collection of written text consisting of all structured and/or unstructured text in sets of written records containing diagnostic or descriptive information regarding individuals in a population.

Reference herein to “individual” refers to any single animate and/or inanimate object and/or any single being, including but not limited to human beings.

Reference herein to “cohort” refers to any population, set, or subset of individuals about which predictions using the instant innovation are made.

Most predictive modeling methods rely solely on structured discrete data types, whereas important characteristics of individuals are stored in the form of unstructured free text in electronic databases. These approaches require considerable effort by subject matter experts (practitioners and scientists) to produce a condition-specific predictive model.

It is therefore desirable to have a fully-automated process that can analyze unstructured text in written records and that is flexible enough to be applied to substantially any condition or outcome without the need of human experts to design and fine-tune the analytical model. Using the information contained in unstructured text fields in addition to structured data can significantly improve the accuracy of predictive models.

Efforts to use unstructured text have mainly focused on applying Natural Language Processing (NLP) techniques to extract specific terms or phrases and to generate values that fit within existing structured fields. The present invention uses a fully automated and generalizable NL approach to utilize the unstructured text in records to predict individuals with any condition, action, or outcome without the need of human experts to design and fine-tune the model. In an embodiment, the present invention relates to a generalized system and process that concatenates records, summarizes records, and provides predictions based on the records. In a particular embodiment, the present invention relates to a system and process that provides predictions based on contextual analysis of unstructured text in data records.

In an embodiment, the present innovation is an automated system and process to utilize descriptive unstructured text in any type of electronic record to characterize individuals within a specified population and to accurately predict individuals in other populations who have any set of conditions, actions, or outcomes that may be of interest to a user of the system. In an initial embodiment, individual-specific documents are created by concatenating all unstructured text fields from the individual's records. The individual's records may then be processed using standard NLP approaches to clean artifacts that artificially affect model performance. Next, a collection, described as a corpus, is built which contains documents for the entire population of interest. Additionally, terms in documents are given weights that convey the importance of each term in each document. Information retrieval utilizing Latent Semantic Indexing (LSI) is performed on the document collection to reduce the dimensionality of the document-by-term matrix into a lower dimensional matrix or matrices. The reduced matrix or matrices produce a “concept” space in which individuals and terms are represented. A computer module was developed to rank individuals in a population based on conceptual relatedness to any individual or plurality of individuals with the target behavior, characteristic, or outcome. The system may then combine and score a set of queries pertaining to individuals at a range of relatedness values to produce a final list of ranked individuals who have high relationship to the query set.

The activation and utilization of the system may involve training and optimizing a predictive model which utilizes concepts extracted from records pertaining to a set of individuals with target conditions, actions, or outcomes, and then applying them to a new set of individuals to predict future outcomes.

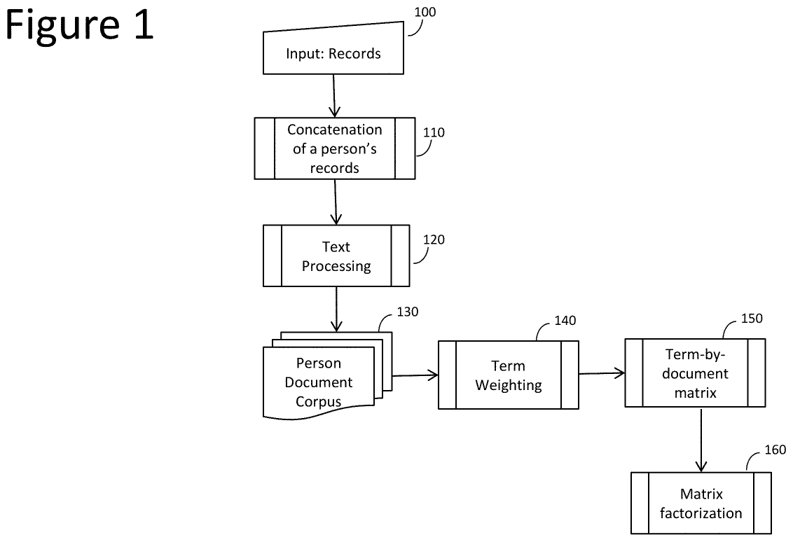

Turning now to FIG. 1, a flowchart representing the process of building a corpus, calculating term weights, summarizing individuals and performing matrix factorization consistent with certain embodiments of the present invention is shown. The system requires input of text records 100 from a system containing records about individuals, typically in XML format. The unstructured text fields for individuals are extracted from records dating back to the earliest encounter of each individual with a database related to a particular domain or discipline. The text from all individual encounters is then concatenated into one document 110. The document is then processed using NLP methods 120, to remove information known to artificially skew or impact model performance. The collection of all individual documents in a domain or discipline is represented in a document corpus 130. The document corpus 130 includes tags which identify from which record each constituent part of the corpus originated. A standard term weighting method 140 (e.g. tf−idf, log entropy, etc) is applied to the corpus, such that each term in the corpus is assigned a weight derived from the frequency of the term in the individual's document with respect to the frequency of the term across all documents in the corpus. Using the weighted terms, a high dimensional and sparse term-by-document matrix 150 is constructed in which each term in the corpus is represented as a vector across the entire population of individuals. Similarly, an individual can be represented as a vector of weighted terms in the term-by-document matrix 150. Finally, in a non-limiting example, LSI, employing singular value decomposition or principle component analysis, 160 is performed to reduce the dimensionality of the matrix into concept space. In this manner, an individual can be represented as a highly specific ‘collection of words’ which can be used to derive relationships.

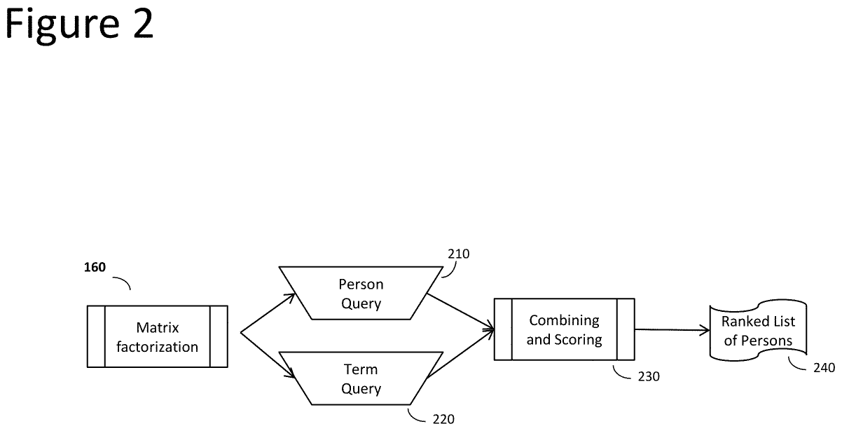

Turning now to FIG. 2, a flowchart representing the process of querying the concept matrix, combining and scoring multiple queries, and producing a ranked (prioritized) list of individuals consistent with certain embodiments of the present invention is shown. The lower dimensional matrix 160 can be queried using any term or combination of terms 220 to rank individuals in the corpus according to literal or conceptual relatedness to the query using a similarity score. Likewise, an entire individual document 210 can be used to rank other individuals in the corpus according to relatedness to the query using a similarity score. Each type of query produces a single ranking of all individuals in the corpus along with a similarity score. In 230, given a single threshold of the similarity score, multiple queries can be combined in tabular format and used to re-rank the population of individuals in the corpus based on relatedness to multiple queries. In this manner, a final ranked list 240 is provided in which high ranking individuals have similarity to a subset of the queries provided by the user.

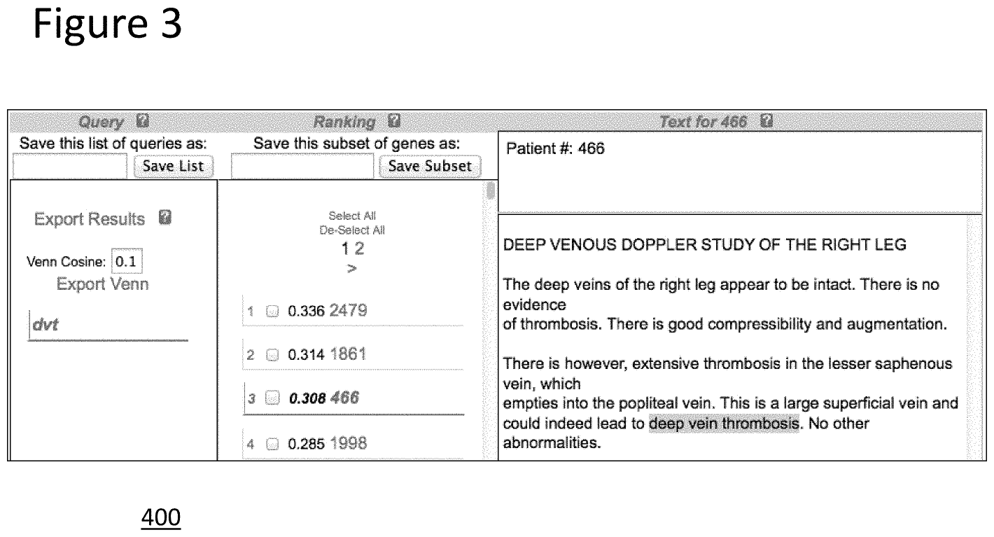

Turning now to FIG. 3, an embodiment of the system and process user interface showing a ranking of individuals based on conceptual similarity to a single query or plurality of queries, where a query can be any term, combination of terms, entire individual record, or combination of individual records, consistent with certain embodiments of the present invention is shown. In a non-limiting healthcare example, this figure shows a screenshot 400 of the system where the query ‘dvt’, an abbreviation for deep vein thrombosis, was used to rank all individuals in the corpus. Highly ranked individuals by the system typically contain the actual query ‘dvt’ in the record. However, it is important to note that the system also highly ranks individuals even if the term dvt is not explicitly mentioned in the record, such as individual (patient) #466 in the example presented herein. Therefore, the system is able to deduce synonyms automatically based on conceptualization of the unstructured text as a result of LSI.

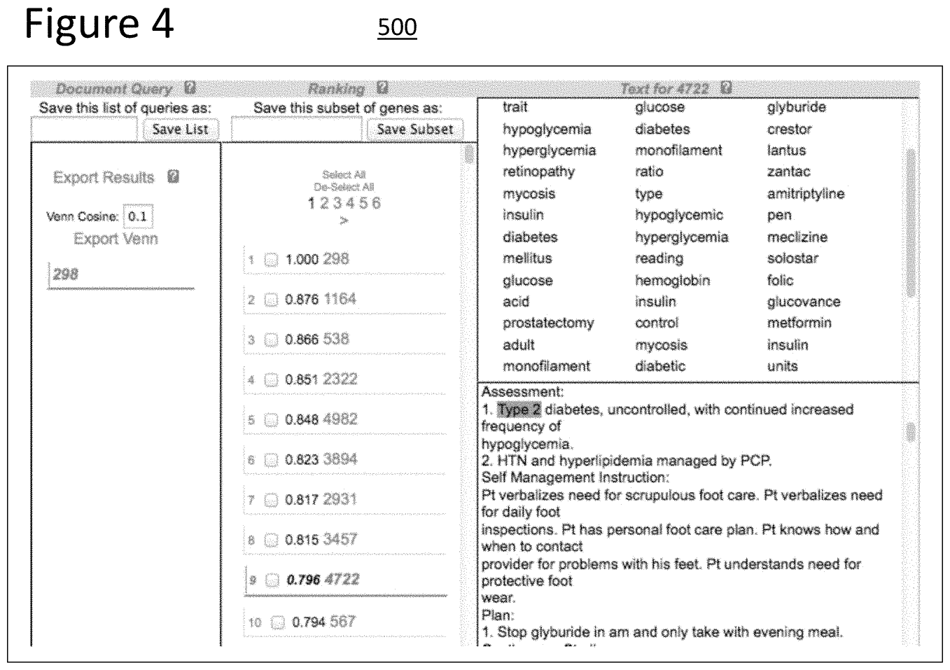

Turning now to FIG. 4, an embodiment of the system and process user interface showing a ranked list of individuals in a given population according to semantic similarities to multiple queries consistent with certain embodiments of the present invention is shown. In a non-limiting healthcare example, this figure shows a screenshot 500 of the system where the query is an entire individual document (individual #298). In this case, all individuals in the population are ranked based on a similarity score which is derived from a combination of all weighted words in the query individual's record. In a non-limiting example, the primary diagnosis of individual (patient) #298 is Type-2 Diabetes. The system returns individuals who also have Type-2 diabetes, such as individual (patient) #4722 (ranked 9 on the list as shown). Also, the system summarizes the individuals automatically by listing top ontology terms mapped to weighted terms extracted from the individual's record. In this non-limiting example, SNOMED filtered terms such as hypoglycemia, hyperglycemia, retinopathy etc. may be displayed on the left column of the upper right-hand panel as shown in the figure. In addition, the top ranked drugs such as Crestor, Lantus, Zantac, etc. associated with this individual may be listed in the right column, in the upper right-hand panel of the figure, although the positioning and/or appearance of the data presented should not be considered limiting.

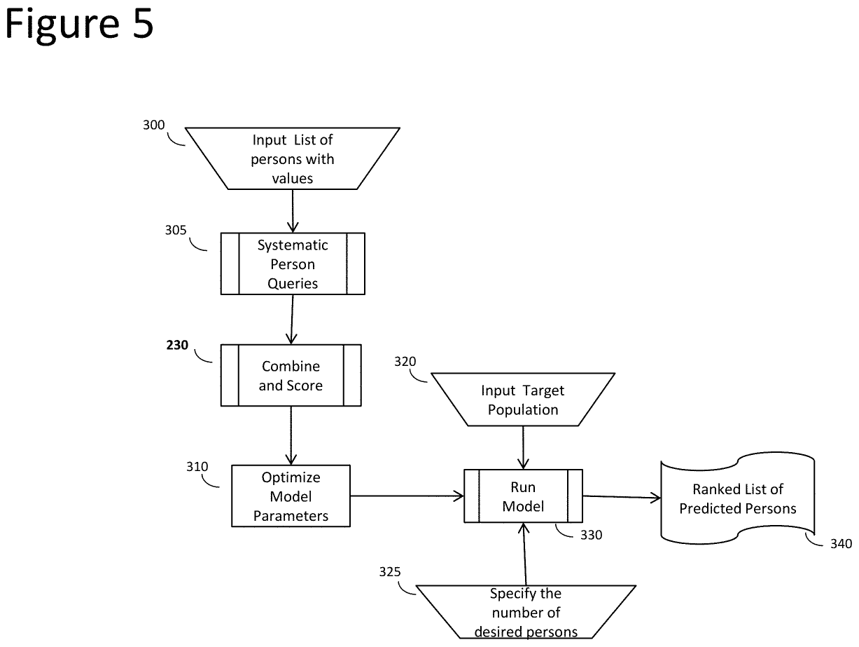

Turning now to FIG. 5, a flowchart representing the process of predictive modeling, where the model is trained based on a set of individuals from the population corpus with the desired characteristics or outcomes, is optimized and is applied to a new population of individuals to produce a ranked list of individuals with high likelihood of having the desired condition, action, or outcome consistent with certain embodiments of the present invention is shown. This figure shows the workflow for the predictive modeling system. The system requires that users provide a list of individuals with corresponding outcome values 300. Outcome values may be related to any value, recorded or derived or any combination thereof, related to the individual. The system 305 performs systematic individual queries against the entire population of individuals, starting from the highest ranked individual, and combinations thereof based on the values provided by the user. The results of the queries are combined 230 as described in FIG. 1. The optimized model 310, considers the following parameters: 1) the number of individuals used for the query, 2) the threshold for the similarity score, 3) the frequency of association to query individuals, 4) the recall value of the individuals returned, 5) the precision value of the individuals returned. The system 310 finds the optimal parameters for predicting the desired condition, action, or outcome on the current or training population. The optimized predictive model 330 can be run on a new set of individuals 320 or the existing set of individuals, considering the desired number of individuals by the user 325. As a result, the system may provide a ranked list of individuals 340 which have the highest likelihood of the desired condition, action, or outcome.

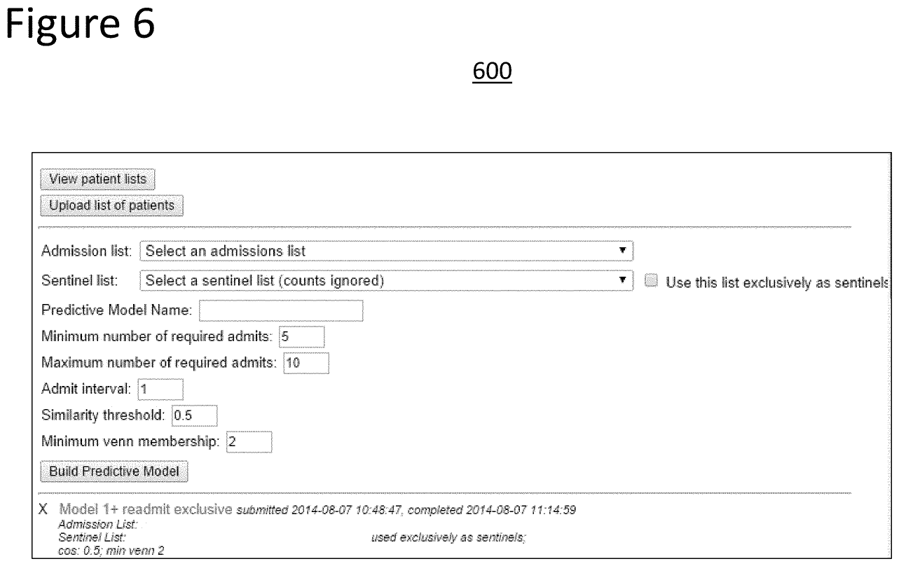

Turning now to FIG. 6, an embodiment of the system and process user interface which allows users to select a training population, specify model parameters, and execute the predictive model on a new target population consistent with certain embodiments of the present invention is shown. In a non-limiting healthcare example, this figure shows a screenshot 600 of the interface wherein users are able to provide a list of individuals and outcome values, select a training population and assign threshold values for parameters of the model.

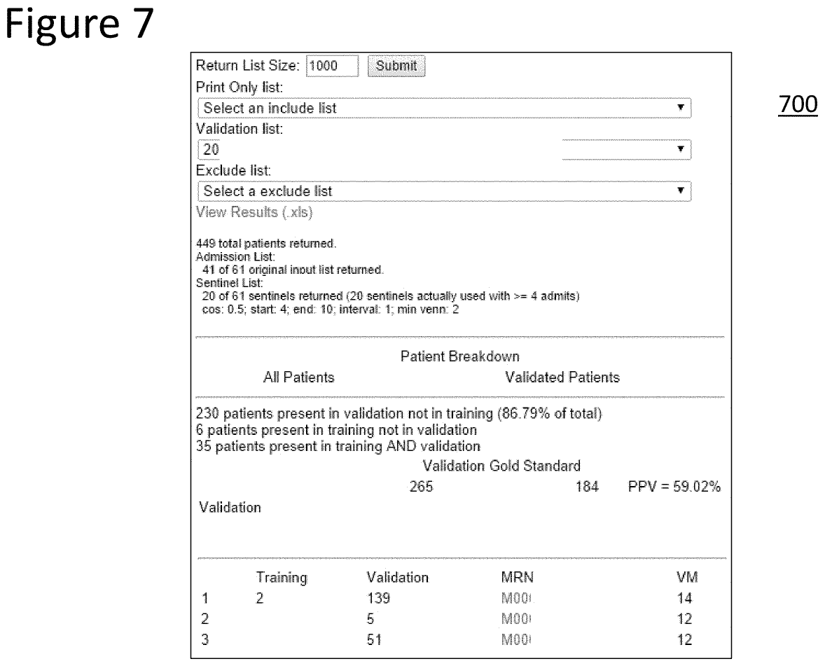

Turning now to FIG. 7, an embodiment of the system and process user interface which displays the output of an optimized model on a selected population consistent with certain embodiments of the present invention is shown. In a non-limiting healthcare example, this figure shows a screenshot 700 showing the interface wherein users are able to select a population for validation of the model and produce performance metrics (such as positive predictive value, counts, memberships, etc.) on this dataset. The performance as measured by the positive predictive value and odds ratio of the predictive modeling system is shown in TABLE 1.

In an embodiment, the model predicts condition, action, or outcomes at a level much higher than random chance. In this non-limiting example from a healthcare implementation, the performance of the model is shown for three different individual populations in TABLE 1.

TABLE 1

| | | | Positive | |
|---|---|---|---|---|
| | | Baseline | Predictive | Odds |
| Condition | Population | Incidence | Value | Ratio |
| Hospital admission | Medicare | 14.8% | 40.5% | 2.74 |
| Hospital admission | Oncology | 34.8% | 49.2% | 1.41 |
| Hospital admission | Emergency Dept. | 40.7% | 69% | 1.70 |

While certain illustrative embodiments have been described, it is evident that many alternatives, modifications, permutations and variations will become apparent to those skilled in the art in light of the foregoing description.

We claim:

1. A process for optimizing a predictive modeling method comprising the steps of:
providing written database records of a population of individuals, each individual having corresponding condition, action, or outcome score values;
processing said written database records by using Natural Language Processing;
building an individual document corpus from said written database records processed by using Natural Language Processing;
weighting terms in said corpus by assigning a weight to each term in the corpus to calculate a similarity score;
given a threshold of said similarity score, combining multiple rankings to re-rank a population of individuals in said corpus;
iterating selected modeling parameters to achieve a best precision fit against said similarity score; and
transmitting data associated with said re-ranked population of individuals to a user.

2. The process of claim 1, where said processing of said written database records is performed by concatenation of unstructured text fields from said individual's written records, and where processing said written database records by using Natural Language Processing is performed on written documents in a corpus.

3. The process of claim 1, where said lower-dimensional matrix concept space is queried using a given individual's documents in said corpus to rank other individual's documents in said corpus to produce a ranking of said other individuals in said corpus using said similarity score.

4. The process of claim 1, where a ranking of individuals comprises:
constructing a high-dimensional and sparse term-by-document matrix from said weighted terms;
reducing the dimensionality of said term-by-document matrix into a lower-dimensional matrix concept space; and
querying said lower-dimensional matrix concept space to produce a single ranking of individuals in said corpus.

5. The process of claim 1 where certain modeling parameters comprise at least:
the number of individuals used for each said query of said multiple queries;
said threshold of said similarity score;
a frequency of association to query of said individuals of said corpus;
a recall value of said individuals returned by said query; and
a precision value of said individuals returned by said query.

6. A system for optimizing a predictive modeling method comprising:
a server;
a user interface;
said server having one or more modules for performing the steps of:
receiving written database records of a population of individuals, each individual having corresponding condition, action, or outcome score values processing said written database records by using Natural Language Processing;
building an individual document corpus from said written database records processed by using Natural Language Processing;
weighting terms in said corpus by assigning a weight to each term in the corpus to calculate a similarity score;
given a threshold of said similarity score, combining multiple rankings to re-rank a population of individuals in said corpus;
iterating certain modeling parameters to achieve a best precision fit against said similarity score; and
transmitting data associated with a re-ranked population of individuals to one or more users.

7. The system of claim 6, where said processing of said written database records is performed by concatenation of unstructured text fields from said individual's written records, and where processing said written database records by using Natural Language Processing is performed on written documents in a corpus.

8. The system of claim 6, where said lower-dimensional matrix concept space is queried using a given individual's documents in said corpus to rank other individual's documents in said corpus to produce a ranking of said other individuals in said corpus using said similarity score.

9. The system of claim 6, where a ranking of individuals comprises:
constructing a high-dimensional and sparse term-by-document matrix from said weighted terms;
reducing the dimensionality of said term-by-document matrix into a lower-dimensional matrix concept space; and
querying said lower-dimensional matrix concept space to produce a single ranking of individuals in said corpus.

10. The system of claim 6 where certain modeling parameters comprise at least:
the number of individuals used for each said query of said multiple queries;
said threshold of said similarity score;
a frequency of association to query of said individuals of said corpus;
a recall value of said individuals returned by said query; and
a precision value of said individuals returned by said query.
